(19) United States
(12) Patent Application Publication
(10) Pub. No.: US 2012/0090867 A1
(43) Pub. Date: Apr. 19, 2012

(54) CONVERTIBLE SWITCH PLATE

(76) Inventor: Alex Marrero, Woodbridge (CA)

(21) Appl. No.: 13/004,920

(22) Filed: Jan. 12, 2011

Related U.S. Application Data
(60) Provisional application No. 61/392,563, filed on Oct. 13, 2010.
(60) Provisional application No. 61/392,564, filed on Oct. 13, 2010.

(51) Int. Cl. H02G 3/08

(52) U.S. Cl. 174/50

(57) ABSTRACT

Apparatus for use with a wall-mounted electrical receptacle box is disclosed and comprises a backer plate which, in use, overlies the box in the manner of a conventional switch plate. The backer has one or more receivers defined therein, each being adapted to, in use, receive a respective Decora-type switch. The apparatus further comprises a cover plate and, for each of said one or more receivers, an adapter plate, the adapter plate being adapted to: occupy said each receiver; and receive a conventional toggle switch in the manner in which a conventional toggle-type switch plate receives a conventional toggle switch. The cover, in use, engages the backer in snap-fit relation and provides access, with respect to said each receiver: (i) when in use with the adapter provided therefore, any toggle switch received by said adapter; and (ii) when in use otherwise than with the adapter, any Decora-type switch occupied thereby.

### CROSS-REFERENCE TO RELATED APPLICATION

This application claims the benefit of U.S. Provisional Patent Application No. 61/392,564 filed Oct. 13, 2010 and is incorporated herein by reference

### FIELD OF THE INVENTION

The invention relates to the field of home decor retailing.

### BACKGROUND OF THE INVENTION

The style and color of electrical switches and switch plates is a matter of significant concern to many homeowners and interior decorators. In the home decor retailing industry, this requires a wide variety of products to be carried in inventory, which adds to costs.

### SUMMARY OF THE INVENTION

Apparatus for use with a wall-mounted electrical receptacle box forms one aspect of the invention. This apparatus comprises a backer plate, one or more adapter plates and a cover plate. The backer plate, in use, overlies the box in the manner of a conventional switch plate and has one or more receivers defined therein, each of said one or more receivers being adapted to, in use, receive a respective Decora-type switch. The one or more adapter plates are provided one for each of said one or more receivers, said one adapter plate being adapted to occupy said each receiver; and receive a conventional toggle switch in the manner in which a conventional toggle-type switch plate receives a conventional toggle switch. The cover plate, in use, engages the backer plate in snap-fit relation and provides access, with respect to said each receiver: (i) when in use with the adapter plate provided therefor, any toggle switch received by said adapter plate; and (ii) when in use otherwise than with the adapter plate, any Decora-type switch received thereby.

According to another aspect of the invention, the receiver can be adapted to receive the Decora-type switch in the manner in which a conventional Decora-type switch cover plate receives a Decorata-type switch and the adapter can be adapted to occupy said each receiver in the manner in which a conventional Decora-type switch occupies a conventional Decora-type switch plate.

According to another aspect of the invention, the backer plate can be screwed to said box in use.

According to another aspect of the invention, the backer plate can be secured in use in the manner of a conventional switch plate.

According to another aspect of the invention, the one or more receivers can consist of three receivers.

According to another aspect of the invention, the adapter plate can be adapted to occupy said each receiver in press-fit relation.

According to another aspect of the invention, the cover plate can have defined therein, for each receiver, a pass-through; and each receiver can (i) define all aperture which, when said receiver is in receipt of a Decora-type switch, is occupied by said Decora-type switch; and (ii) have a peripheral boss surrounding said aperture which, in use, occupies the pass-through defined for said each receiver.

According to another aspect of the invention, in use, the cover plate can conceal the adapter plate but for, with respect to each receiver, the peripheral boss.

According to another aspect of the invention, the adapter plate can have a base part and a central part protruding from the base part, the central part, when said adapter plate is in use with the backer plate, occupying the receiver for which said adapter plate is provided.

According to another aspect of the invention, when the adapter plate is in use with the backer plate, the base part of the adapter plate and the backer plate can engage one another in a press-fit lap-type joint.

Other advantages, features and characteristics of the present invention, as well as methods of operation and functions of the related elements of the structure, and the combination of parts and economies of manufacture, will become more apparent upon consideration of the following detailed description and the appended claims with reference to the accompanying photographs, the latter being briefly described hereinafter.

### BRIEF SUMMARY OF THE DRAWINGS

The description herein makes reference to the accompanying drawings wherein like reference numerals refer to like parts throughout the several views and wherein:

FIG. 1 is a front perspective view showing apparatus according to an exemplary embodiment of the invention assembled for one possible use;

FIG. 2 is a rear perspective view of the structure of FIG. 1;

FIGS. 3 and 3A are front exploded perspective views showing the parts of FIG. 1;

FIGS. 4 and 4A are a rear perspective exploded views of the structure of FIGS. 3; and

FIG. 5 is a view showing the structure of encircled area 5 of FIG. 3 assembled for use.

### DETAILED DESCRIPTION OF THE ILLUSTRATIVE EMBODIMENT

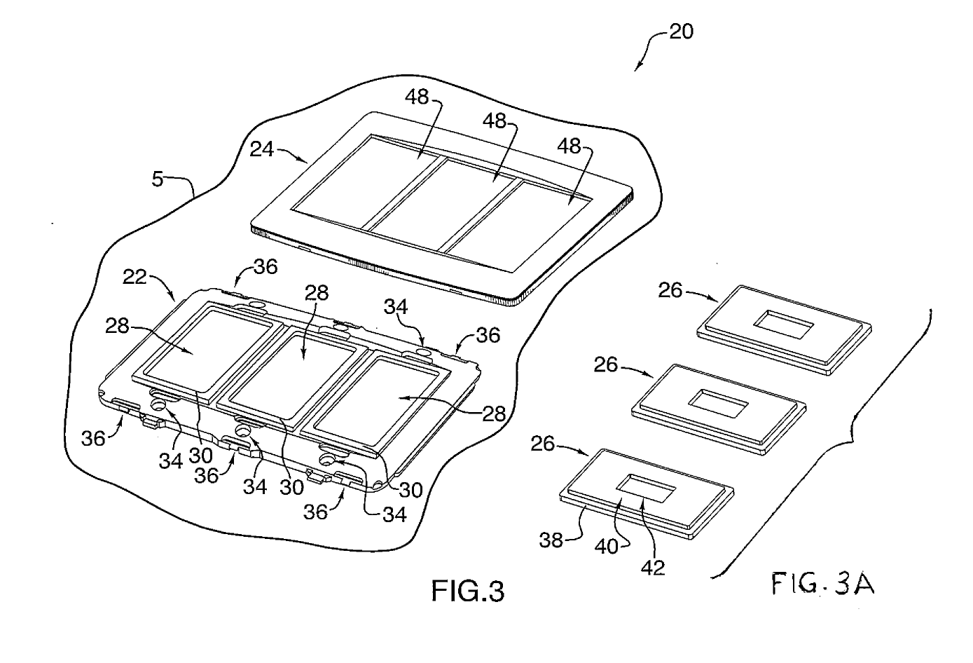

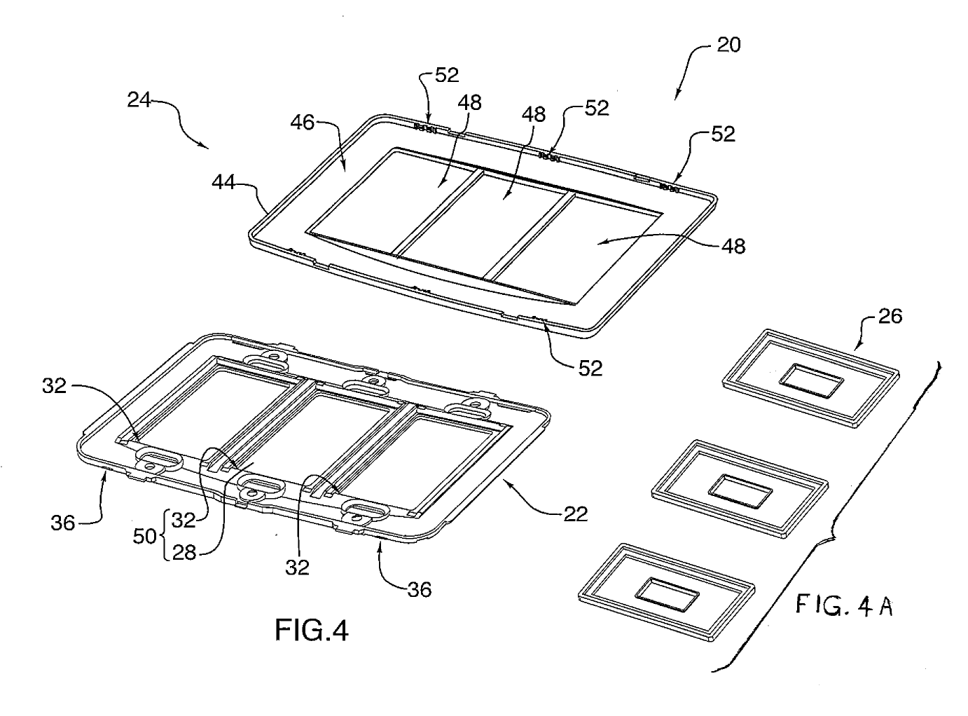

Apparatus 20 according to an exemplary embodiment of the invention is shown in FIGS. 3, 3A, 4 and 4A and will be seen to include a backer plate 22, a cover plate 24 and three adapter plates 26.

The backer plate 22 will be seen to be a generally planar structure having three rectangular apertures 28 defined therein. Each aperture 28 is about the size of a conventional Decora-type switch actuator (not shown). On one side of the backer plate, each aperture 28 will be seen to be surrounded by a peripheral boss 30. On the other side of the backer plate, a socket 32 will be seen, which communicates with the aperture 28 to define a receiver 50. Flanking each aperture 28 is a pair of bores 34, which are spaced-apart a distance equivalent to the distance between the mounting holes of a conventional electrical switch plate (not shown). On the outer perimeter of the backer plate 22, a plurality of tabs 36 is visible.

The adapter plates 26 are provided one for each receiver 50 and will be seen to include a base part 38 and a central part 40 protruding from the base part 38. The central part 40 is about the size of a conventional Decora-type switch actuator/toggle (not shown). The base part 38 is about the size of one of the backer plate sockets 32. Defined centrally in the central part 40 is a slot 42 which is about the size of a conventional switch toggle (not shown).

The cover plate 24 will be seen to have a protruding rim 44 bounding a hollow 46 which is about the size of the backer plate 22 and to have, for each receiver 50, a pass-through 48 communicating with the hollow 46. The cover plate 24 also has a plurality of detents 52 project from the rim 44.

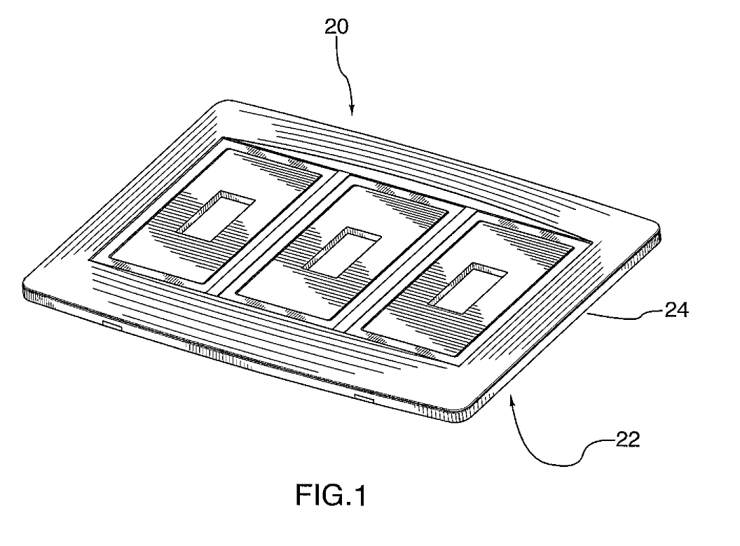

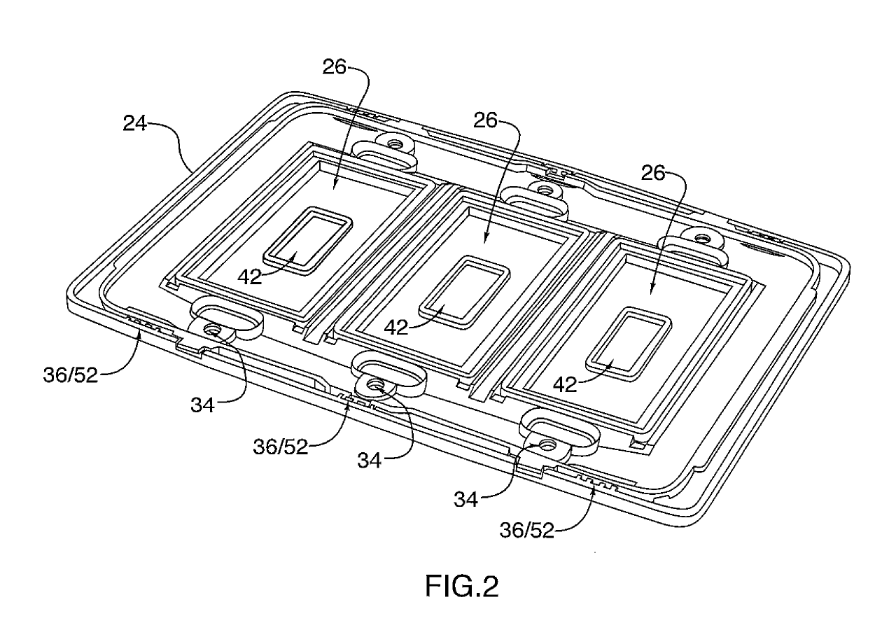

The structure of FIGS. 3, 3A, 4 and 4A is shown assembled in FIGS. 1 and 2. Herein:
the cover plate 24 engages the backer plate 22 in snap-fit relation, by virtue of engagement between the tabs 36 and detents 52;
each peripheral boss 30 occupies the pass-through 48 defined for the receiver 50 which it surrounds;
each adapter plate 26 occupies the receiver 50 in the manner in which a conventional Decora-type switch occupies a conventional Decora-type switch plate, specifically, the central part 40 occupies the aperture 28 and the base part 38 occupies the socket 32, with the base part 38 of the adapter plate 26 and the backer plate 22 engaging one another in a press-fit lap-type joint.

So assembled, it will become immediately apparent to persons of ordinary skill that the slots 42 are positioned and shaped such that, if the apparatus of FIG. 1 were positioned against a wall-mounted triplex receptacle box containing three toggle switches mounted therein, the slots 42 would receive the toggles and provide access thereto for use, in the manner of a conventional triple-toggle cover plate.

The apparatus 20 can indeed be used in this fashion. To do so, one would merely:
ensure that the adapter plates 26 were securely press-fit into the sockets 32
screw the backer plate 22 to the triplex box in the manner in which a conventional cover plate would have been secured thereto, i.e. using the bores 34; and
snap the cover plate 24 over the backer plate 22.

However, the apparatus 20 can also be used with Decora-type switches substituted for any or all of the conventional toggle switches. In this application, the procedure for use would be identical to the above, but for the removal of adapter plates 26 in circumstances wherein the Decora-type switches are deployed.

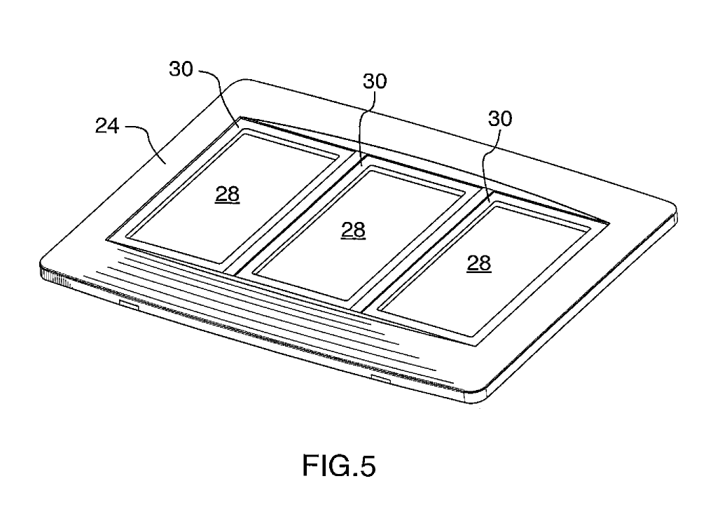

FIG. 5 shows the apparatus as it would be assembled for use with three Decora-type switches.

In all such uses, the exemplary apparatus will be understood to provide a neat and finished appearance, with the backer plate 22 fully concealed but for the peripheral bosses 30, and with the slots 42 and apertures 28, as the case may be, occupied by respective toggle and Decora-type switches in a conventional manner.

In one embodiment, the backer plate and the adapter plates are sold as set, and a series of cover plates, in different colors, are sold separately. In another embodiment, the backer plate, the adapter plates and a white cover plate are sold as a set, and a series of cover plates, in different colors, are sold separately.

Both arrangements provide an advantageous combination to retailers in terms of the usefulness of the product, i.e. flexibility for Decora and non-Decora switches, while at the same time, allowing for color changes with a relatively low number of products to be carried in inventory.

Whereas but a single apparatus is shown and described, variations are possible.

For example, whereas a backer plate with three receivers is shown, the backer plate could have greater or lesser numbers of receivers.

Further, whereas the protruding bosses are visible in use in the exemplary embodiment, this is not necessary.

As well, whereas detents and tabs are shown to provide for a snap-fit engagement between the backer and cover plate, other arrangements to provide snap-fit engagement are possible and contemplated.

Additionally, whereas the illustrated backer plate mounts in a manner analogous to a conventional switch plate, the backer plate could, for example, be mounted using the screws by which the switches themselves are mounted.

Accordingly, the invention should be understood as limited only by the accompanying claims, purposively construed.

What is claimed is:

1. Apparatus for use with a wall-mounted electrical receptacle box, the apparatus comprising:
a backer plate which, in use, overlies the box in the manner of a conventional switch plate, the backer plate having one or more receivers defined therein, each of said one or more receivers being adapted to, in use, receive a respective Decora-type switch;
for each of said one or more receivers, an adapter plate, the adapter plate being adapted to occupy said each receiver; and
receive a conventional toggle switch in the manner in which a conventional toggle-type switch plate receives a conventional toggle switch,
a cover plate which, in use, engages the backer plate in snap-fit relation and provides access, with respect to said each receiver,
when in use with the adapter plate provided therefore, any toggle switch received by said adapter plate; and
when in use otherwise than with the adapter plate, any Decora-type switch occupied thereby.

2. Apparatus according to claim 1, wherein the receiver is adapted to receive the Decora-type switch in the manner in which a conventional Decora-type switch cover plate receives a Decora-type switch and the adapter is adapted to said each receiver in the manner in which a conventional Decora-type switch occupies a conventional Decora-type switch plate.

3. Apparatus according to claim I wherein the backer plate is screwed to said box in use.

4. Apparatus according to claim 1 wherein the backer plate is secured in use in the manner of a conventional switch plate.

5. Apparatus according to claim 1 wherein the one or more receivers consists of three receivers.

6. Apparatus according to claim 1 wherein the adapter plate is adapted to occupy said each receiver in press-fit relation.

7. Apparatus according to claim 1 wherein:
the cover plate has defined therein, for each receiver, a pass-through;
each receiver defines an aperture which, when said receiver is in receipt of a Decora-type switch, is occupied by said Decora-type switch; and
has a peripheral boss surrounding said aperture which, in use, occupies the pass-through defined for said each receiver.

8. Apparatus according to claim 7 wherein, in use, the cover plate conceals the adapter plate but for, with respect to each receiver, the peripheral boss.

9. Apparatus according to claim 7 wherein the adapter plate has a base part and a central part protruding from the base part, the central part, when said adapter plate is in use with the backer plate, occupying the receiver for which said adapter plate is provided.

10. Apparatus according to claim 9 when said adapter plate is in use with the backer plate, the base part of the adapter plate and the backer plate engage one another in a press-fit lap-type joint.
